(19) United States
(12) Patent Application Publication
(10) Pub. No.: US 2021/0097470 A1
(43) Pub. Date: Apr. 1, 2021

(54) BUSINESS MANAGEMENT DEVICE AND BUSINESS MANAGEMENT METHOD

(71) Applicant: Nippon Telegraph and Telephone Corporation, Tokyo (JP)

(72) Inventors: Yuichi Suto, Musashino-shi, Tokyo (JP); Manabu Nishio, Musashino-shi, Tokyo (JP)

(21) Appl. No.: 16/971,086

(22) PCT Filed: Feb. 18, 2019
(86) PCT No.: PCT/JP2019/005786

§ 371 Date: Aug. 19, 2020

(30) Foreign Application Priority Data
Feb. 20, 2018 (JP) 2018-028319

(51) Int. Cl. G06Q 10/06; G06Q 10/10

(52) U.S. Cl. CPC G06Q 10/06398; G06Q 10/20; G06Q 10/105; G06Q 10/063114

(57) ABSTRACT

[Problem] A task content performed by a worker having a task environment which changes every moment is required to be easily recognized.

[Solution] A business management apparatus 10 includes a worker operation information acquisition unit 102 configured to continuously acquire worker operation information during an operation time of a worker W, the worker operation information including at least any of an action and a location in the operation time, during the operation time, a task content estimation unit 106 configured to estimate a content of a task performed by the worker W during a predetermined time slot in the operation time based on worker operation information, and an operation history recording unit 110 configured to record the content of the task and a time slot in which the task is performed, as operation history information of the worker W. For each task predicted to be performed by the worker W, the task content estimation unit 106 defines task feature information including at least any of the action and the location when the task is performed, and collates the worker operation information and the task feature information with each other to estimate a task content performed by the worker W during the predetermined time slot.

### TECHNICAL FIELD

The present invention relates to a business management apparatus and a business management method for recording the content of a task performed by a worker.

### BACKGROUND ART

In recent years, with the decrease in the working population, there has been a demand for more efficient work in business. In response to such a demand, a visualization technique for recognizing the actual situation of the business by a worker has been developed.

For example, Patent Literature 1 discloses a technology for managing business of a worker who mainly performs a desk task (computer task), and uses a log output from a computer to visualize the content of business performed by the worker.
For example, Patent Literature 2 discloses a technology for managing business of a worker such as a nurse, who performs the business while moving at a plurality of places. This technology allows the content of business performed by the worker to be visualized based on a detection result of a motion sensor or the like.
On the other hand, a technology in which a computer analyzes behavioral history data of a worker, which has been obtained as described above, and objectively evaluates the business content is also proposed.

### CITATION LIST

### Patent Literature

Patent Literature 1: JP 2016-224819 A

Patent Literature 2: JP 2010-224879 A

### SUMMARY OF THE INVENTION

### Technical Problem

The above-described related art is suitable for managing a worker who performs business in a specific environment. However, the above-described related art has a problem in that it is not possible to accurately measure a task performed by a worker of which a working place changes throughout the day, for example, a worker having a business scope including a desk task and a field task.

For example, in a case where the business content of a worker is network maintenance, a place or a tool for the task (for example, a task of creating materials using a computer in an office or the like, or a task of racking in a machine room), which is used for performing a series of pieces of business often changes constantly. In order to visualize such business being performed by a worker, a task is required to be recognized somehow in accordance with an environment.

The present invention has been made in view of such circumstances, and an object of the present disclosure is to easily recognize a task content performed by a worker whose task environment changes constantly.

### Means for Solving the Problem

To achieve the object described above, according to an embodiment of the present invention described in claim 1, a business management apparatus including a worker operation information acquisition unit configured to continuously acquire worker operation information during an operation time of a worker, the worker operation information including at least any of an action and a location in the operation time, a task content estimation unit configured to estimate a content of a task performed by the worker during a predetermined time slot in the operation time based on the worker operation information, and an operation history recording unit configured to record the content of the task and the time slot in which the task is performed, as operation history information of the worker. For each task predicted to be performed by the worker, the task content estimation unit defines task feature information including at least any of the action and the location when the task is performed, and collates the worker operation information and the task feature information with each other to estimate the task content performed by the worker during the predetermined time slot.

According to an embodiment of the present invention described in claim 5, a business management method includes continuously acquiring worker operation information during an operation time of a worker, the worker operation information including at least any of an action and a location in the operation time, estimating a content of a task performed by the worker during a predetermined time slot in the operation time based on the worker operation information, and recording the content of the task and the time slot in which the task is performed, as operation history information of the worker. While estimating the content of the task, for each task predicted to be performed by the worker, the task content performed by the worker in the predetermined time slot is estimated by collating the action and the location included in the worker operation information, using task feature information including at least any of the action and the location when the task is performed.

In this manner, it is possible to record a task performing history of a worker who may perform tasks that vary in content in irregular places, without making the worker aware, and to easily recognize the task content.

According to an embodiment of the present invention described in claim 2, the business management apparatus according to claim 1 further includes an additional information acquisition unit configured to acquire additional information including at least any of a content of a task scheduled to be performed by the worker or a content of a task completed by the worker. The task content estimation unit estimates the task content performed by the worker during the predetermined time slot, based on the additional information, the worker operation information, and the task feature information.

According to an embodiment of the present invention described in claim 6, the business management method according to claim 5 further includes acquiring additional information including at least any of a content of a task scheduled to be performed by the worker or a content of a task completed by the worker. While estimating the content of the task, the task content performed by the worker during the predetermined time slot is estimated based on the additional information, the worker operation information, and the task feature information.

In this manner, it is possible to estimate a task content performed by a worker based on information of a task scheduled to be performed or a task which has been actually performed in addition to information (worker operation information) of an action, a location, or the like of the worker. Thus, it is possible to improve estimation accuracy of the task content.

According to an embodiment of the present invention described in claim 3, the business management apparatus according to claim 1 or 2 further includes a task feature change unit configured to receive a change of a defined content of the task feature information.

According to an embodiment of the present invention described in claim 7, the business management method according to claim 5 or 6 further includes receiving a change of a defined content of the task feature information.

In this manner, it is possible to appropriately change task feature information being a criterion of determination when a worker, a task-involved person (task requester), or the like performs a task content. For example, in a case where an estimation result of the task content is different from the actual task content, it is possible to set a more appropriate task feature and to improve estimation accuracy of the task content.

According to an embodiment of the present invention described in claim 4, the business management apparatus according to any one of claims 1 to 3 further includes a frequent task extraction unit configured to extract a task content of which the number of times of being performed by the worker is greater than a predetermined threshold value, in accordance with the operation history information during a predetermined period, and to present the extracted task content to the worker.

According to an embodiment of the present invention described in claim 8, the business management method according to any one of claims 5 to 7 further includes extracting a task content of which the number of times of being performed by the worker is greater than a predetermined threshold value, in accordance with the operation history information during a predetermined period, and presenting the extracted task content to the worker.

In this manner, it is possible to present a highly frequent task to a worker and to provide a determination material for examining improvement of efficiency of the task or automation of the task, to the worker.

### Effects of the Invention

According to the present disclosure, it is possible to easily recognize a task content performed by a worker having a task environment which changes every moment.

### BRIEF DESCRIPTION OF DRAWINGS

FIG. 1 is a functional block diagram illustrating a configuration of a business management apparatus according to an embodiment of the present invention.

FIG. 2 is a table showing an example of business classification data according to the embodiment of the present invention.

FIG. 3 is a table showing an example of information acquired by a worker operation information acquisition unit according to the embodiment of the present invention.

FIG. 4 is a schematic explanatory diagram illustrating information input to or output from the business management apparatus according to the embodiment of the present invention.

FIG. 5 is a table showing an example of task feature information according to the embodiment of the present invention.

FIG. 6 is an explanatory diagram illustrating an example of operation history information according to the embodiment of the present invention.

### DESCRIPTION OF EMBODIMENTS

Hereinafter, preferred embodiments of a business management apparatus and a business management method according to the present invention will be described in detail with reference to the accompanying drawings.

### Embodiment

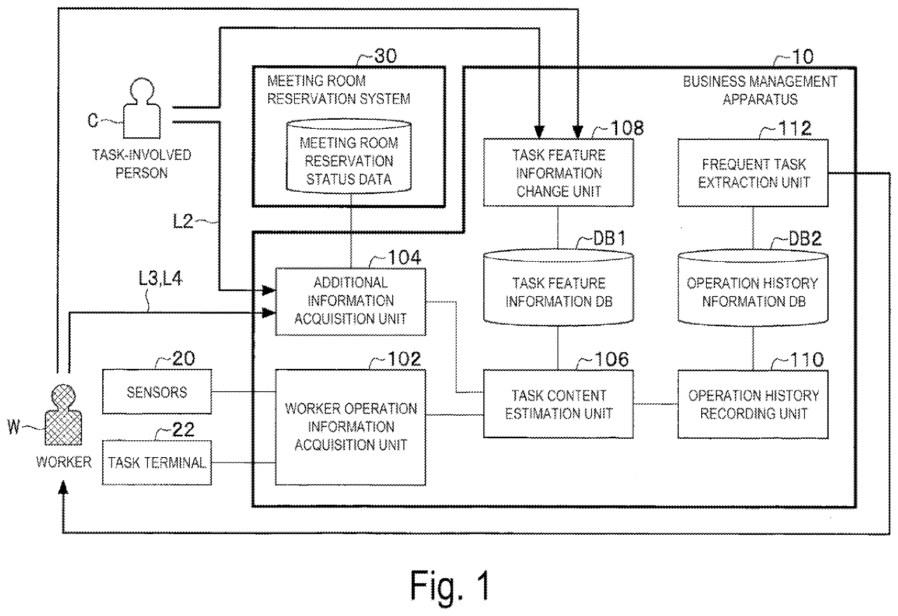

FIG. 1 is a functional block diagram illustrating a configuration of a business management apparatus 10 according to an embodiment of the present invention.
The business management apparatus 10 is installed by a user (a company, an organization, or the like) of a worker W, and records the state of business performed by the worker W. In the embodiment, one worker W will be described as an example. However, in practice, a plurality of workers Ws are individually identified, and the business management apparatus records the state of business performed by each worker W.

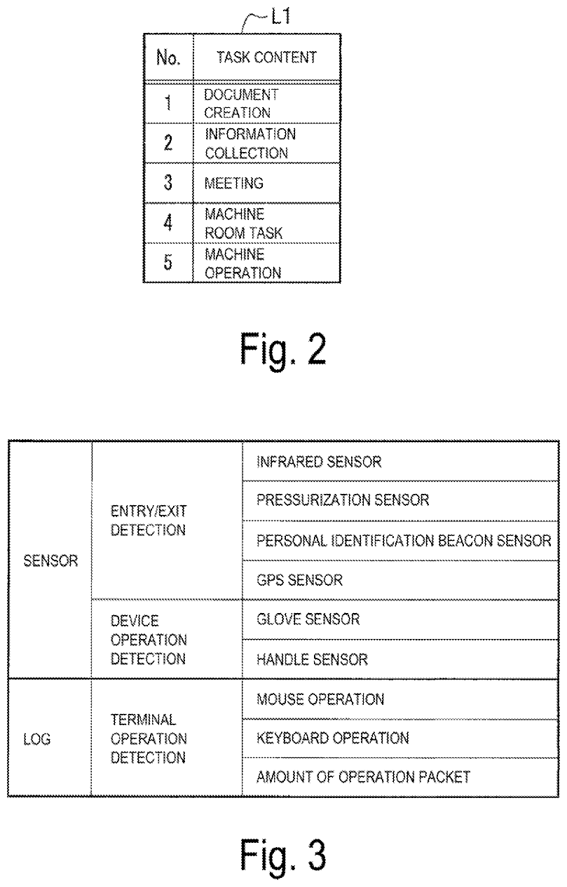

In the embodiment, network maintenance business will be described as an example of the business of the worker W. It is assumed that the worker W mainly performs a task classified by task contents as illustrated in business classification data L1 in FIG. 2. That is, it is assumed that tasks performed by the worker W are classified into five types: “1. DOCUMENT CREATION”, “2. INFORMATION COLLECTION”, “3. MEETING”, “4. MACHINE ROOM TASK”, and “5. MACHINE OPERATION”.

It is assumed that “1. DOCUMENT CREATION” and “2. INFORMATION COLLECTION” are performed at the own seat of the worker W. It is assumed that “3. MEETING” refers to reserving a meeting room by a meeting room reservation system 30 and performing a meeting in the reserved meeting room. “4. MACHINE ROOM TASK” refers to a task (for example, adding racks or task related to wiring) operated in a machine room other than a machine operation. “5. MACHINE OPERATION” refers to a task of operating a machine (computer or the like) at the machine room or a place other than the machine room.

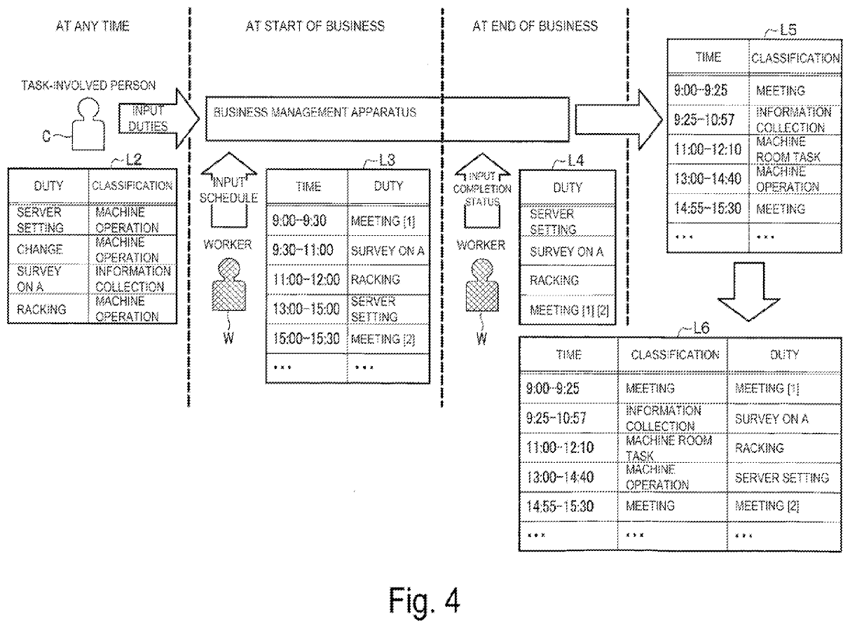

The worker W basically receives a request of a task from a task requester as an example of a task-involved person C (task request data L2 described later, see FIG. 4), and performs the task as business. It is assumed that the worker W inputs a task schedule of the day at the start of business as task schedule data L3 (see FIG. 4) to the business management apparatus 10, and, at the end of task, inputs a task completion status of the day as task completion data L4 (see FIG. 4) to the business management apparatus 10.

As illustrated in FIG. 1, the business management apparatus 10 includes a worker operation information acquisition unit 102, an additional information acquisition unit 104, a task content estimation unit 106, a task feature information change unit 108, an operation history recording unit 110, a frequent task extraction unit 112, a task feature information database DB1, and an operation history information database DB2.

The worker operation information acquisition unit 102 continuously acquires worker operation information during an operation time of the worker W. The worker operation information includes at least any of an action and a location in the operation time of the worker W.

The worker operation information acquisition unit 102 acquires detection results from various sensors 20 arranged at various places in a business area of the worker W or acquires an operation status log of a task terminal (information terminal such as a computer or a tablet) 22 from the terminal 22. The worker operation information also includes identification information of the sensor used for acquiring sensor information. The type (category) of sensor and the installation place of the sensor are specified based on the identification information of the sensor, and are associated with an action of the worker W. For example, as described later, if the type of sensor is “INFRARED SENSOR”, the type of sensor is associated with the behavior of the worker W such as entering or leaving a specific room. If the type of sensor is “KEYBOARD”, “MOUSE”, or the like, and the acquired information is a log, these are associated with the behavior (task) of the worker W such as a terminal operation. That is, the worker operation information includes information indicating what kind of sensor has been used for acquiring information.

FIG. 3 is a table showing an example of the types of sensors 20 and logs acquired from the task terminal 22.

Examples of the sensors 20 include sensors that detects entering and leaving of the worker W into and from, for example, a specific room (in the embodiment, machine room, meeting room, business room where the worker W is seated, or the like).
Specifically, for example, an infrared sensor (entry/exit detection by body temperature heat generation, passage detection by blocking near-infrared rays, or the like), a pressurization sensor (detection of pressurization to a predetermined place to specify the position of a person, or the like), a personal identification beacon sensor, and a GPS sensor may be employed.
Another example of the sensors 20 includes a sensor that detects an operation on a specific device, for example. Specifically, for example, a glove sensor that detects the movement of a glove used when remotely controlling a device by hand movement, and a handle sensor that detects a handle operation state of a forklift in a machine room or the like may be employed.

Examples of the log acquired from the task terminal 22 include a time at which a mouse operation (click) or a keyboard operation (keystroke) occurs, and an amount of operation packets.

In the embodiment, when the log is acquired from the task terminal 22, information for identifying the worker W who performs a task on the terminal is acquired. As the method, various known methods in the related art may be applied: for example, task is performed in a state where each worker W performs log-in; a beacon sensor for personal identification is provided for each terminal to recognize the worker W at the closest distance as a task subject; and face authentication is performed using a camera of a terminal.

The worker operation information acquisition unit 102 integrates and stores the detection result obtained from the sensors 20 and log information obtained from the task terminal 22 or the like, that is, information obtained from different information sources, as information associated with the worker W.

The additional information acquisition unit 104 acquires additional information including at least any of the content of a task scheduled to be performed by the worker W and the content of a task completed by the worker W.

FIG. 4 is a schematic explanatory diagram illustrating information input to or output from the business management apparatus 10.
The task related person C (task requester) inputs task request data L2, which lists the content (duty) of a task to request the worker W to do, to the business management apparatus 10. At this time, the task requester labels each requested duty with a classification according to the business classification data L1 illustrated in FIG. 2. The labeling task may be performed by the worker W.
In the example of FIG. 4, “SEVER SETTING” classified as “MACHINE OPERATION”, “CHANGE” classified as “MACHINE OPERATION”, and “SURVEY ON A (survey regarding an event A)” classified as “INFORMATION COLLECTION”, and “RACKING TASK” classified as “MACHINE ROOM TASK” are requested.

As described above, the task content of the worker W is roughly classified at the summary level (large classification), which can suppress collection of unnecessary surplus information (information of finer granularity than is necessary) in a case of simply combining the technology in the related art. That is, it is possible to estimate the task content and the task time from the minimum necessary information.

The worker W inputs the task schedule data L3 of the day to the business management apparatus 10 at starting work (at the start of an operation). The task schedule data L3 includes a task schedule time slot and a task content (duty).

In the example of FIG. 4, it is scheduled that the worker W has a first meeting from 9:00 to 9:30, performs a survey on A from 9:30 to 11:00, performs a racking task from 11:00 to 12:00, performs a server setting from 13:00 to 15:00, and has a second meeting from 15:00 to 15:30 (omitted below).

The worker W inputs the task completion data L4 of the day to the business management apparatus 10 at ending work (at the end of operation). The task completion data L4 includes the task content (duty) of the completed task.

In the example of FIG. 4, the L4 task completion data reports that the worker W performed a server setting, a survey on A, racking, and first and second meetings on this day.
Among the above-described data, the task request data L2 and the task schedule data L3 correspond to the content of the task scheduled to be performed by the worker W, and the task completion data L4 corresponds to the content of the task completed by the worker W.

As another example of the additional information, for example, meeting room reservation status data in the meeting room reservation system 30 (see FIG. 1) may be acquired. The meeting room reservation status data includes at least the name of the reserved meeting room, information on a time slot in which the meeting room is used (scheduled meeting time), and identification information of the participant (worker W) participating in the meeting in the meeting room.

In this case, the additional information acquisition unit 104 accesses a terminal (that performs the meeting room reservation system 30) other than the business management apparatus 10, and acquires additional information.

Returning to the description of FIG. 1, the task content estimation unit 106 estimates the content of the task performed by the worker W in a predetermined time slot during the operation time, using the worker operation information acquired by the worker operation information acquisition unit 102.

More specifically, for each task predicted to be performed by the worker W, the task content estimation unit 106 defines task feature information including at least any of the action and the location when the task is performed, and collates the worker operation information and the task feature information with each other to estimate a task content performed by the worker W during the predetermined time slot.

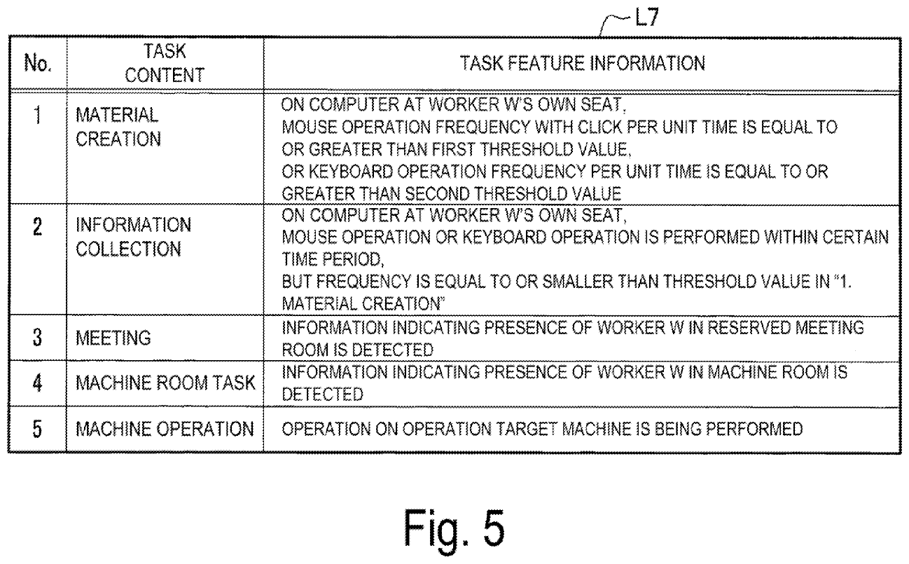

FIG. 5 is a table showing an example of task feature information L7.

In the task feature information L7, a logic for estimating the task content is defined by task-related features (whether or not a predetermined action has been performed, frequency of the action being performed, information of a source (place) of the information, or the like) which are obtained from the worker operation information acquired for each worker W.
In the embodiment, the task feature information L7 is defined corresponding to the five business classification examples in the business classification data L1 illustrated in FIG. 2. The task feature information L7 is stored in the task feature information database DB1 (see FIG. 1).

For example, regarding “1. DOCUMENT CREATION”, a condition as follows is defined as the task feature information: “ON COMPUTER AT WORKER W′S OWN SEAT, MOUSE OPERATION FREQUENCY WITH CLICK PER UNIT TIME IS EQUAL TO OR GREATER THAN FIRST THRESHOLD VALUE, OR KEYBOARD OPERATION FREQUENCY PER UNIT TIME IS EQUAL TO OR GREATER THAN SECOND THRESHOLD VALUE”.

Regarding “2. INFORMATION COLLECTION”, a condition as follows is defined as the task feature information: “ON COMPUTER AT WORKER W'S OWN SEAT, MOUSE OPERATION OR KEYBOARD OPERATION IS PERFORMED WITHIN CERTAIN TIME PERIOD, BUT FREQUENCY IS EQUAL TO OR SMALLER THAN THRESHOLD VALUE IN “1. DOCUMENT CREATION”.

Regarding “3. MEETING”, a condition as follows is defined as the task feature information: “INFORMATION INDICATING PRESENCE OF WORKER W IN RESERVED MEETING ROOM IS DETECTED” (for example, a case where a personal identification beacon has reacted to a Wi-Fi access point).

Regarding “4. MACHINE ROOM TASK”, a condition as follows is defined as the task feature information: “INFORMATION INDICATING PRESENCE OF WORKER W IN MACHINE ROOM IS DETECTED”.
Regarding “5. Machine operation”, a condition as follows is defined as the task feature information: “OPERATION ON OPERATION TARGET MACHINE IS BEING PERFORMED”(for example, the amount of operation packets is equal to or more than a third threshold value).

If a time slot satisfies any of the above conditions, the task content estimation unit 106 estimates that the worker W has performed the business corresponding to the condition setting in the time slot. If a time slot does not satisfy any of the above conditions, the task content estimating unit 106 estimates that the worker W performs no business in the time slot, at least regarding the business defined by the business classification data L2.

Referring to FIG. 4 as an example, the task content estimation unit 106 collates the worker operation information and the task feature information L7 with each other, and outputs operation classification data indicated by the reference sign L5.

The followings can be found from the operation classification data L5. Information (worker operation information) based on the action or the like of the worker W conforming to the “MEETING” of the task feature information L7 is provided in a period of 9:00 to 9:25, thus, the task content estimation unit 106 estimates that meeting is performed in this time slot. Information (worker operation information) based on the action or the like of the worker W conforming to the “INFORMATION COLLECTION” of the task feature information L7 is provided in a period of 9:25-10:57, thus, the task content estimation unit 106 estimates that information collection is performed in this time slot. Information (worker operation information) based on the action or the like of the worker W conforming to the “MACHINE ROOM TASK” of the task feature information L7 is provided in a period of 11:00-12:10, thus, the task content estimation unit 106 estimates that the machine room task is performed in this time slot. Information (worker operation information) based on the action or the like of the worker W conforming to the “MACHINE OPERATION” of the task feature information L7 is provided in a period of 13:00-14:40, thus, the task content estimation unit 106 estimates that the machine operation is performed in this time slot. Information (worker operation information) based on the action or the like of the worker W conforming to the “MEETING” of the task feature information L7 is provided in a period of 14:55 and 15:30, thus, the task content estimation unit 106 estimates that meeting is performed in this time slot.

In a case where the additional information acquired by the additional information acquisition unit 104 is further obtained, the task content estimation unit 106 estimates the task content performed by the worker W during the predetermined time slot, based on the additional information, the worker operation information, and the task feature information L7.

That is, it is possible to classify the task performed by the worker W to some extent (by the classification defined in the business classification data L1), by collating the worker operation information and the task feature information L7 with each other as described above. If the additional information is further used as a reference, it is possible to specify a specific duty of the task performed by the worker W.

Referring to FIG. 4 as an example, the task content estimation unit 106 collates the operation classification data L5 and the additional information with each other, and outputs operation history data indicated by the reference sign L6.

For example, the task content estimation unit 106 estimates that the “MEETING” from 9:00 to 9:25 is the “MEETING [1]”. This is because the schedule of the “MEETING [1]” is entered in this time slot in the task schedule data L3, and a completion report of the “MEETING [1]” is also entered in the task completion data L4.
Similarly, the task content estimation unit 106 estimates that the “INFORMATION COLLECTION” from 9:25 to 10:57 corresponds to the “SURVEY ON A”, the “MACHINE ROOM TASK” from 11:00 to 12:10 corresponds to the “RACKING”, the “MACHINE OPERATION” from 13:00 to 14:40 corresponds to the “SERVER SETTING”, and the “MEETING” from 14:55 to 15:30 corresponds to the “MEETING [2]”. The task content estimation unit 106 outputs the operation history data L6 in which the task content more detailed than the operation classification data L5 is specified.

The task content estimation unit 106 may determine a specific content, for example, of “SERVER SETTING” as “ACCOUNT REGISTRATION” for a task content specified as the “SERVER SETTING” for the “MACHINE OPERATION” from 13:00 to 14:40, with a known log analysis technique, and may generate the more detailed task content as the operation history data L6.

Returning to the description of FIG. 1, the task feature information change unit 108 receives a change of the definition content of the task feature information L7 from at least any of the worker W and a person (task-involved person C) involved in the task performed by the worker W.

By allowing the definition content of the task feature information L7 to be changed as described above, the determination criterion can be changed to improve estimation accuracy of the task content, for example, in a case where the content of the operation history data L6 (see FIG. 4) output by the task content estimation unit 106 is different from the actual content. That is, the accuracy of the operation history data L6 is improved by enabling feedback from the worker W or the like to the estimation result of the task content estimation unit 106.
Specifically, for example, as a possible measure in a case where it is erroneously recognized that “INFORMATION COLLECTION” has been performed during the time slot when the “DOCUMENT CREATION” has been actually performed, the first threshold value or the second threshold value being the task features (see FIG. 5) corresponding to the “DOCUMENT CREATION” can be changed to a smaller value. Instead of the process of receiving the change of the definition content of the task feature information L7 from the outside, the task feature information change unit 108 may continuously determines whether the content of the operation history data L6 is different from the actual content, for example, by using an artificial intelligence (AI) and recognize the tendency of misrecognition, and thus autonomically revise (change) the task features (threshold value of the task feature or the very content of the task feature).

The operation history recording unit 110 records the content of the task estimated by the task content estimation unit 106 and the time slot in which the task has been performed, as the operation history information of the worker W. That is, the operation history recording unit 110 stores the operation history data L6 output from the task content estimation unit 106, in the operation history information database DB2 as the operation history information. The operation history information recorded in the operation history information database DB2 may be used as a reference by, for example, the worker W and the task-involved person C.

The frequent task extraction unit 112 extracts frequent task in accordance with the operation history information on a plurality of operation days, frequent task being the task content of which the frequency of being performed by the worker W is high (the number of being performed is greater than a predetermined threshold value). The frequent task extraction unit 112 presents the extracted task content to the worker W. At this time, it is preferable to refer to the operation history information within a predetermined period starting from the current time, for example, “for the past one month”. This is because the task content of the worker W may change due to factors such as the start and end of a business project, a department change, and the like.

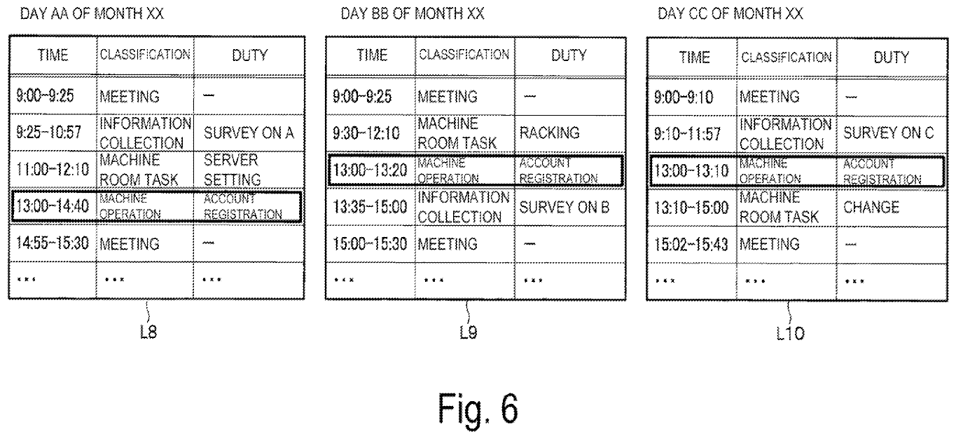

FIG. 6 is an explanatory diagram illustrating an example of the operation history information.

FIG. 6 illustrates the operation history information L8 to L10 for three operation days. Referring to the operation history information L8 to L10 for three days, it is understood that an “ACCOUNT REGISTRATION” task classified as the machine operation is performed all day. In this case, the frequent task extraction unit 112 presents the “ACCOUNT REGISTRATION” task to the worker W as the frequent task. As a method of presenting the task to the worker W, for example, the “ACCOUNT REGISTRATION” task may be highlighted (colored, enlarged characters, etc.) as frequent task on a screen showing the operation history information L8 to L10, or information indicating that the “ACCOUNT REGISTRATION” has been extracted as frequent task may be transmitted to a terminal of the worker W or the like by e-mail.
In a case where each task has been performed several number of times or more during a predetermined period (a plurality of operating days) (in a case of being greater than a predetermined threshold value), a logic, such as the logic for which task is extracted as the frequent task, is set in the frequent task extraction unit 112 in advance.
As described above, presenting the task having a highly frequent task to the worker W can provide a determination material for the worker W, for example, in examining improvement of efficiency of the task or automation of the task, for example.

As described above, according to the business management apparatus 10 according to the embodiment, it is possible to record a task performing history of a worker W who may perform tasks that vary in content in irregular places, without making the worker W aware, and to visualize a business status of the worker W.

At that time, even when the task place of the worker W changes, for example, from the PC task performed at the seat of the worker W to the machine room task, the business management apparatus 10 can determine the task content and the task time by using the minimum necessary information recognized at the summary level. Thus, the business management apparatus 10 can suppress the collection of unnecessary surplus information when determining the task content.

In the embodiment, the business management apparatus 10 according to the present invention has been described as determining the task content relating to the network maintenance business performed by the worker W, but the present invention is not limited to this. The business management apparatus 10 according to the present invention can be applied to various kinds of business in which a worker W moves from one task place to another in accordance with a change in task content.

### REFERENCE SIGNS LIST

10 Business management apparatus
20 Sensors
22 Task terminal
102 Worker operation information acquisition unit
104 Additional information acquisition unit
106 Task content estimation unit
108 Task feature information change unit
110 Operation history recording unit
112 Frequent task extraction unit
DB1 Task feature information database
DB2 Operation history information database
C Task-involved person
W Worker

1. A business management apparatus comprising:
a worker operation information acquisition unit configured to continuously acquire worker operation information during an operation time of a worker, the worker operation information comprising at least one of an action or a location in the operation time;
a task content estimation unit configured to estimate a content of a task performed by the worker during a predetermined time slot in the operation time based on the worker operation information; and
an operation history recording unit configured to record the content of the task and the predetermined time slot in which the task is performed, as operation history information of the worker,
wherein, for each task predicted to be performed by the worker, the task content estimation unit is configured to (i) define task feature information comprising at least one of the action or the location based on the task being performed, and (ii) collate the worker operation information and the task feature information with each other to estimate a task content performed by the worker during the predetermined time slot.

2. The business management apparatus according to claim 1, further comprising:
an additional information acquisition unit configured to acquire additional information including at least one of a content of a task scheduled to be performed by the worker or a content of a task completed by the worker,
wherein the task content estimation unit is configured to estimate (i) the task content performed by the worker during the predetermined time slot, based on the additional information, (ii) the worker operation information, and (iii) the task feature information.

3. The business management apparatus according to claim 1, further comprising:
a task feature change unit configured to receive a change of a defined content of the task feature information.

4. The business management apparatus according to claim 1, further comprising:
a frequent task extraction unit configured to extract a task content of which a number of times of being performed by the worker is greater than a predetermined threshold value, in accordance with the operation history information during a predetermined period, and to present the extracted task content to the worker.

5. A business management method comprising:
continuously acquiring worker operation information during an operation time of a worker, the worker operation information comprising at least one of an action or a location in the operation time;
estimating a content of a task performed by the worker during a predetermined time slot in the operation time based on the worker operation information; and
recording the content of the task and the predetermined time slot in which the task is performed, as operation history information of the worker,
wherein, while estimating the content of the task, for each task predicted to be performed by the worker, a task content performed by the worker in the predetermined time slot is estimated by collating the action and the location included in the worker operation information, using task feature information comprising at least one of the action or the location based on the task being performed.

6. The business management method according to claim 5, further comprising:
acquiring additional information including at least one of a content of a task scheduled to be performed by the worker or a content of a task completed by the worker,
wherein, while estimating the content of the task, the task content performed by the worker during the predetermined time slot is estimated based on the additional information, the worker operation information, and the task feature information.

7. The business management method according to claim 5, further comprising: receiving a change of a defined content of the task feature information.

8. The business management method according to claim 5, further comprising:
extracting a task content of which a number of times of being performed by the worker is greater than a predetermined threshold value, in accordance with the operation history information during a predetermined period, and
presenting the extracted task content to the worker.
